(19) United States
(12) Patent Application Publication
(10) Pub. No.: US 2015/0191391 A1
(43) Pub. Date: Jul. 9, 2015

(54) METHOD FOR PRODUCING A SHEET OF SELECTIVELY ETCHED GLASS

(71) Applicant: AGC GLASS EUROPE, Louvain-La-Neuve (BE)

(72) Inventors: Fabrice Sinapi, Spy (BE); Christine Deneil, Ohey (BE)

(73) Assignee: AGC GLASS EUROPE, Louvain-La-Neuve (BE)

(21) Appl. No.: 14/409,176

(22) PCT Filed: Jun. 7, 2013
(86) PCT No.: PCT/EP2013/061824

§ 371 Date: Dec. 18, 2014

(30) Foreign Application Priority Data
Jun. 19, 2012 (BE) 2012/0416

(51) Int. Cl. C03C 15/00

(52) U.S. Cl. CPC C03C 15/00

(57) ABSTRACT

The present invention concerns a method of selective chemical etching of a glass sheet, using a mask, making it possible to limit the etching of the glass under the edges of the mask, and to obtain a glass sheet selectively etched with patterns which can be very small and of which the contours exhibit a high level of sharpness. In particular, the invention concerns a method for producing a selectively etched glass sheet, comprising (i) a masking step which comprises selectively depositing a crosslinkable organic liquid composition on one of the faces of the sheet, using at least one ink-jet head, and the cross-linking of said composition by exposure to ultraviolet radiation; (ii) an etching step during which the areas of said face which are not covered by the crosslinked composition are chemically etched; and (iii) a finishing step which comprises removing said crosslinked composition.

### 1. FIELD OF THE INVENTION

The present invention relates to a method for the manufacture of a glass sheet, a portion of one of the faces of which is etched. In particular, the present invention relates to a method for the manufacture of a glass sheet, a portion of one of the faces of which is chemically etched. In other words, the invention relates to a method for the selective chemical etching of a glass sheet.

The method of the invention exhibits in particular applications in the field of decoration as the partially etched glass sheets which it makes it possible to manufacture exhibit light-scattering translucent regions which can represent decorative patterns. Other fields of application, such as the management of light, the protection of privacy or the connector industry, can also be envisaged.

### 2. SOLUTIONS OF THE PRIOR ART

There are many selective chemical etching methods which make it possible to obtain a specific pattern on the surface of a glass article. These methods can be classified into two main categories:

(i) the methods using an etching treatment selectively applied to the glass; and

(ii) the methods using a protective mask, which is resistant to the chemical etching treatment, making it possible to expose, to the etching treatment, only certain parts of the surface of the glass, and subsequently removed. The pattern thus drawn on the glass corresponds to the negative of the mask applied beforehand.

Among the methods not using a mask but selectively applying the etching substance only at the places to be etched, an existing method provides for the application, to the glass sheet, of hydrofluoric acid (chemical etching) in the form of a viscous paste using a brush (brush procedure). Nevertheless, this procedure requires a manual stage of application with a brush. The result from a pattern point of view is thus dependent on the artistic qualities of the operator. This method is obviously very difficult to use for sheets having large surface areas and it does not make it possible to obtain patterns with outlines of high sharpness. Another method, described in the U.S. Pat. No. 2,127,781, provides for the deposition of the etching substance by screen printing, during which use is made of a screen composed of a synthetic fabric in the form of meshes stretched over a metal frame. However, this method requires a different screen for each pattern and thus has a low degree of freedom with regard to the patterns to be applied. Furthermore, it is also difficult to apply in-line and even more with large surface areas and does not make possible the creation of fine patterns.

As regards the methods using a protective mask, a conventional and basic practice is simply to use a protective mask consisting of adhesive tape, which is resistant to the etching treatment, applied manually for each glass article over the regions which must not be subjected to etching. This technique exhibits several disadvantages. In addition to being lengthy and tedious to carry out, it offers only a low reproducibility of one and the same pattern on different glass articles and it generates patterns, the outlines of which lack sharpness. It obviously does not make it possible either to obtain, on the surface of the glass article, very small patterns with good sharpness.

Other methods of selective etching make use of the application of molten wax to the parts to be protected of the surface of the glass article, in particular by screen printing, by a hot applicator or by inkjet technology. The sharpness of the outlines of the patterns obtained by using such a mask, whatever its deposition technique, remains relatively poor as a result of the etching of the glass under the edges of the wax mask. This “under-etching” results in addition in an uncontrolled increase in the surface area of the textured pattern, in comparison with the negative of the mask applied to the glass. This phenomenon of “under-etching” presents problems, in particular when it is desired to obtain very fine etched patterns. Furthermore, the deposition of wax by the inkjet technique requires heating the printheads in order to melt the wax, which cools and hardens on contact with the colder glass, which results in many problems with regard to the longevity of the printheads (deformation, expansion, and the like) but also with regard to the homogeneity of the printing in the case of large surface areas as the wax cools non-homogeneously, more or less rapidly, as a function of the region of the surface of the glass sheet.

Another method of selective etching, described in the U.S. Pat. No. 4,451,329, provides for the deposition of a mask made of a crosslinkable resin deposited by screen printing or using a brush (brushing) or by a transfer technique. The mask, once applied, is subsequently crosslinked in order to be rendered resistant to the chemical etching treatment. These methods of depositing the mask nevertheless have many disadvantages, some of which have already been set out above. In particular, the transfer technique requires additional stages which are in particular the deposition of the protective material over the transfer sheet and its transfer to the glass sheet. The sharpness of the outlines of the patterns obtained by using such a mask and by using the deposition techniques of the U.S. Pat. No. 4,451,329 is not very good as a result also of the etching of the glass under the edges of the mask applied.

### 3. OBJECTIVES OF THE INVENTION

An objective of the invention is in particular to overcome these disadvantages of the prior art.

An objective of the invention, in at least one of its embodiments, is thus to provide a method for the selective chemical etching of a glass sheet which makes it possible to obtain:

(i) an identicality between the negative of the mask and the textured patterns finally obtained;

(ii) a high sharpness of the outlines of the patterns; and

(iii) patterns having small sizes with a very good resolution.

In particular, an objective of the invention is to obtain a method for the selective chemical etching of a glass sheet which makes it possible to militate, indeed even prevent, the etching of the glass under the edges of the mask.

Another objective of the invention, in at least one of its embodiments, is to provide a method for the selective chemical etching of a glass sheet which is easy to carry out, which is fast and which makes possible good reproducibility of the patterns on the surface of a glass sheet.

Another objective of the invention, in at least one of its embodiments, is to provide a method for the selective chemical etching of a glass sheet which offers a high degree of freedom with regard to the patterns to be created on the glass sheet. High degree of freedom is understood to mean the possibility of creating a large amount of different patterns and a rapid change from one pattern to another.

Finally, another objective of the invention, in at least one of its embodiments, is to provide a method for the selective chemical etching of a glass sheet which can be implemented in-line, that is to say sufficiently rapid to be incorporated in a production line for a completely chemically etched glass sheet, without significantly slowing down the production output of said line.

### 4. ACCOUNT OF THE INVENTION

In accordance with a specific embodiment, the invention relates to a method for the manufacture of a selectively etched glass sheet, comprising the following successive stages:

a) a masking stage, which comprises the selective deposition, on one of the faces of the sheet, of a crosslinkable liquid organic composition by means of at least one inkjet head and the crosslinking of said composition by exposure to ultraviolet radiation;
b) an etching stage, during which the regions of said face not covered by the crosslinked composition are chemically etched; and
c) a finishing stage, which comprises the removal of said crosslinked composition.

Thus, the invention is based on an entirely novel and inventive approach as it makes it possible to solve the abovementioned disadvantages of the prior art and to resolve the technical problem posed.

This is because the inventors have demonstrated, with the sequence of the stages of the method of the invention and in particular by combining the use of a mask based on a crosslinked composition with the deposition of said mask by the inkjet technology, that it is possible to limit, indeed even completely prevent, the phenomenon of “under-etching”, that is to say the etching of the glass under the edges of the mask. The mask obtained in that way is furthermore easily removed from the glass sheet at the end of the treatment. The combination according to the invention thus makes it possible to easily, rapidly and reproducibly obtain a selectively etched glass sheet. Furthermore, this combination makes it possible to obtain etched patterns which can be very small and which have outlines exhibiting great sharpness.

Other characteristics and advantages of the invention will become more clearly apparent on reading the following description of a preferred embodiment, given as simple illustrative and nonlimiting example, and the appended figures, among which:

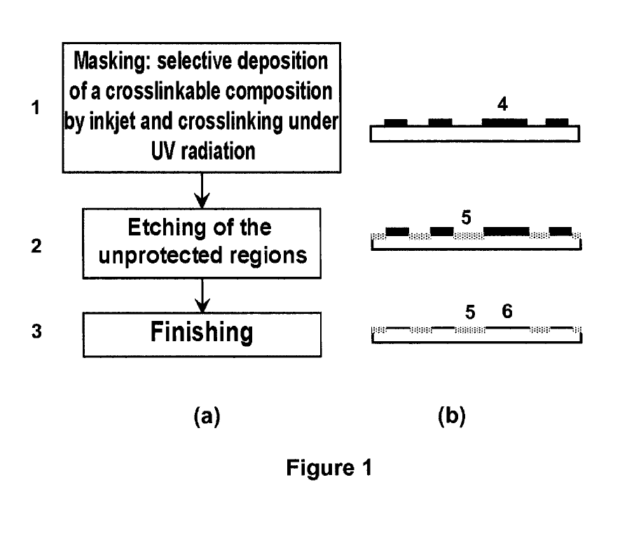

FIG. 1 diagrammatically presents (a) the consecutive stages of the method according to the invention and also (b) the profile in cross-section (scale not observed) of the surface of the sheet obtained after each stage;

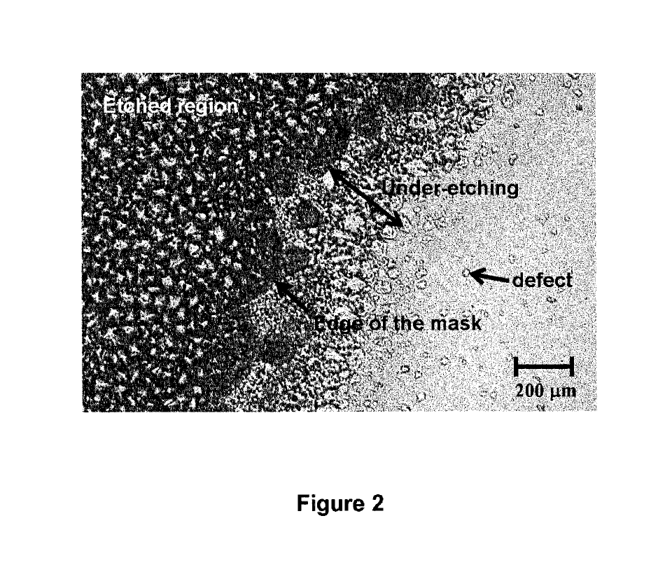

FIG. 2 shows an optical microscopy photograph of a selectively etched glass sheet according to the state of the art, using a wax mask;

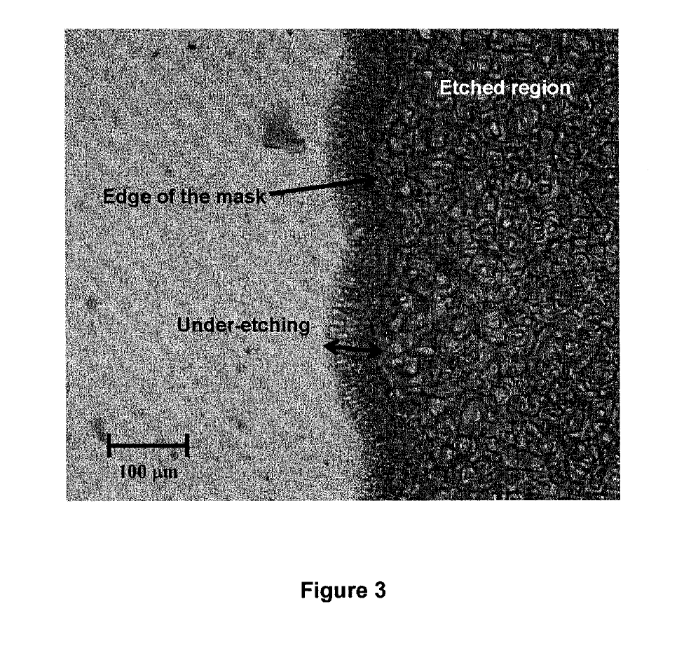

FIG. 3 shows an optical microscopy photograph of a selectively etched glass sheet according to the state of the art, using a mask made of a crosslinked composition and deposited by screen printing;

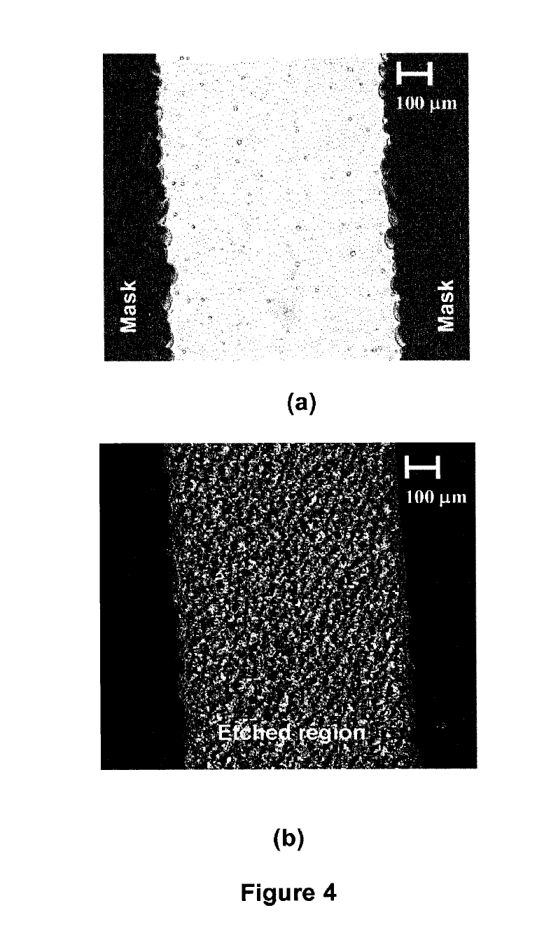

FIG. 4 shows an optical microscopy photograph (a) of a glass sheet covered with a mask deposited according to the invention and (b) of the same glass sheet after etching and removal of the mask according to the invention; and

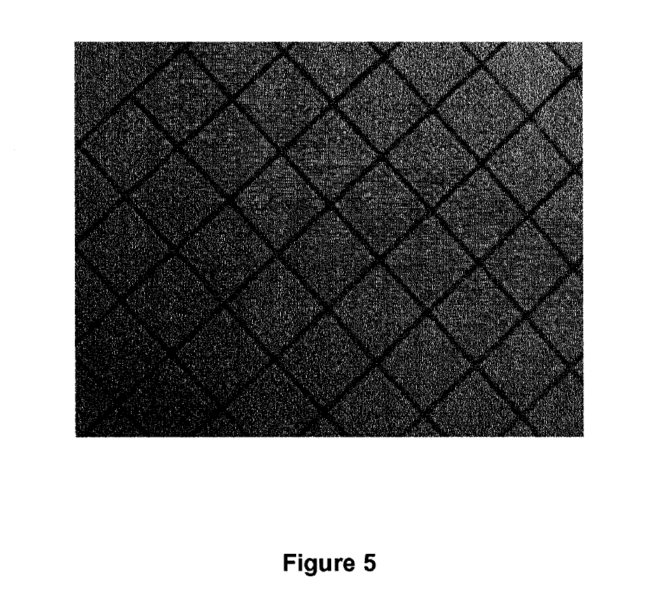

FIG. 5 shows a photograph of a portion of the surface of the glass sheet of FIG. 4(b).

In the invention, etching of the glass is understood to mean the removal of a certain amount of material at the surface of the glass, giving a translucent/scattering aspect to the glass, a specific texture and sometimes roughness. The term “chemical etching” is used when the removal of material is carried out by chemical attack/reaction.

The sheet used in the method according to the invention is made of glass which can belong to various categories. The glass can thus be a glass of soda-lime-silica type, a borate glass, a lead glass, a glass comprising one or more additives homogeneously distributed in its body, such as, for example, inorganic colorant, oxidizing compound, viscosity-regulating agent and/or agent which facilitates melting. Preferably, the glass of the sheet of the invention is of soda-lime-silica type. The glass can be clear, extra-clear or colored in its body. The glass sheet according to the invention can be a completely smooth glass sheet or even an already completely etched glass sheet. According to a preferred embodiment, the glass sheet is a float glass sheet. Very preferably, the glass sheet is a float glass sheet of soda-lime-silica type. The glass sheet can have a thickness ranging from 0.7 to 20 mm.

As illustrated in FIG. 1, the method of the invention comprises a masking stage (1) which encompasses:

(i) the selective deposition, by means of at least one inkjet head, of a crosslinkable liquid organic composition, and

(ii) the crosslinking of the composition by exposure to ultraviolet radiation, so as to form a cured mask (4) which is resistant to the etching stage (2).

Selective deposition is understood to mean the deposition on a portion only of one of the faces of the glass sheet. Crosslinking is understood to mean a stage which makes it possible in particular for an organic composition to cure. The crosslinking according to the invention involves chemical reactions, such as polymerizations, which are induced by the exposure to the ultraviolet radiation. It can also involve drying (by evaporation of the solvent(s) possibly present in the liquid composition). The ultraviolet radiation according to the invention can be radiation of just one wavelength or else alternatively can be radiation comprising several wavelengths.

Advantageously, according to the invention, the crosslinking by exposure to ultraviolet radiation is virtually simultaneous or simultaneous with the deposition of the liquid composition. According to this embodiment, the drops of the liquid composition are cured/crosslinked from their deposition on the glass sheet, thus preventing them from spreading/flowing over said sheet and any deformation of the pattern of the mask which would result therefrom. This is particularly advantageous insofar as, with this embodiment, very fine patterns can be obtained, with a high resolution.

According to the invention, the appropriate organic composition is chosen in particular as a function of the type of chemical etching chosen and it must also be easily removed from the glass sheet once the etching treatment is complete. Organic composition is understood to mean a composition which comprises at least one organic compound. Crosslinkable composition is understood to mean a composition which crosslinks when it is exposed to ultraviolet radiation.

Preferably, the liquid organic composition, before crosslinking, comprises at least one photoinitiator and a mixture of monomers and/or oligomers.

According to one embodiment of the invention, the organic composition comprises at least one photoinitiator, at least one oligomer and at least one comonomer capable of polymerizing with the oligomer. According to the invention, the oligomer can originate from the oligomerization of identical or different monomers. The oligomer can be chosen from acrylate oligomers, such as epoxy acrylate, urethane acrylate or polyester acrylate, and the comonomer can be chosen from mono- or polyfunctional acrylates or other monomers, such as N-vinylpyrrolidone or N-vinylcaprolactam.

Alternatively, according to another embodiment of the invention, the organic composition comprises at least one photoinitiator, at least one monomer and at least one comonomer capable of polymerizing with the monomer. According to this embodiment, the monomer and the comonomer can be chosen from mono- or polyfunctional acrylates or other monomers, such as N-vinylpyrrolidone or N-vinylcaprolactam. The comonomer and the monomer can be identical or different.

According to a specific embodiment, the liquid organic composition, before crosslinking, can in addition already comprise polymers which are soluble in said liquid composition, such as polyvinyl acetate or polyacrylate.

According to another specific embodiment, the liquid organic composition according to the invention optionally comprises one or more of the following components: flow agent, wetting agent, surfactant, solvent, dye, pigment or binder.

According to the invention, the inkjet head can comprise several ejection nozzles capable of ejecting the liquid organic composition in the form of droplets. By way of example, the inkjet head according to the invention can comprise 128 nozzles. Depending on the pattern to be created on the surface of the glass sheet, each nozzle can be activated separately or all the nozzles can be activated together.

According to the invention, the inkjet head can operate according to two technologies: (i) either the continuous jet, during which the droplets are continuously ejected from the head and deflected in part towards the glass, the remainder being recovered and recycled for a further jet cycle, (ii) or the on-request jet, during which only the droplets necessary for the formation of the mask are created and ejected.

According to the invention, the droplets ejected can have a volume ranging from 5 picoliters to 100 picoliters. It is possible to use variable droplet sizes, either by using nozzles having a variable droplet volume or by using nozzles with a droplet volume which is fixed but different between the nozzles. This makes it possible to control or optimize the printing rate as a function of the pattern chosen and/or of the resolution/sharpness of outlines desired. Advantageously, in the case of a pattern which is large in size, the edges of the pattern can be obtained by virtue of droplets which are small in volume (for example, 6 picoliters) and the center of the pattern can be obtained with droplets which are larger in volume (for example, 80 picoliters).

For a given point of the surface of the glass sheet which has to be protected by the mask, the inkjet head provides organic composition at least once at the surface of the glass sheet. Advantageously, for a specific place to be protected of the surface of the glass, the inkjet head provides liquid composition at least twice (with a deposition/crosslinking cycle each time), in order to obtain better masking. Very preferably, for a specific place to be protected of the surface of the glass, the inkjet head provides liquid composition twice (with a deposition/crosslinking cycle each time), in order to obtain optimum masking without slowing down the process.

According to the invention, several inkjet heads can be used to deposit the liquid organic composition in the form of droplets. When several inkjet heads are used, the latter can be fed with different or identical crosslinkable liquid compositions. Each head can advantageously be independently controlled, in its movements and/or in its process for ejection of the droplets.

According to the invention, the rate of the masking stage (i) (or rate of printing of the mask), expressed as surface area of the glass sheet, can vary between 5 and 300 m² per hour. Advantageously, the rate of the masking stage (i), expressed as surface area of the glass sheet, varies between 50 and 150 m² per hour, in order to obtain a compromise between optimum result for the deposition of the mask (4) and speed of the masking stage (1).

According to one embodiment of the invention, the deposition of the crosslinkable liquid composition is carried out on the upper face of the glass sheet positioned substantially horizontally and immobile and the printhead(s) move(s) in both directions of the space in a plane parallel to said glass sheet (“bidirectional” printing). Alternatively, according to another advantageous embodiment in the case of an in-line process, the glass sheet, positioned substantially horizontally, is moving in one direction of the space included in the plane of said sheet and, in this case, the printhead(s) move(s) either in just one direction of the space (“unidirectional” printing), perpendicularly to the direction of the movement of the sheet, or in both directions of the space in a plane parallel to said glass sheet.

According to another embodiment of the invention, the method can comprise, during the masking stage (1), several deposition/crosslinking cycles in order to obtain the final mask. Preferably, during the masking stage (1), the simultaneous deposition and crosslinking can be combined with several deposition/crosslinking cycles.

The chemical etching stage (2) according to the invention can be an acid etching or a basic etching.

The acid etching according to the invention can be carried out conventionally by means of a controlled chemical attack with an aqueous solution based on hydrofluoric acid. The acid etching can be carried out one or more times. Generally, the aqueous acidic solutions used for this purpose have a pH between 0 and 5 and they can comprise, in addition to the hydrofluoric acid itself, salts of this acid, other acids, such as HCl, H₂SO₄, HNO₃, acetic acid, phosphoric acid and/or their salts (for example, Na₂SO₄, K₂SO₄, (NH₄)₂SO₄, BaSO₄, and the like), and also other adjuvants in minor proportions. Alkali metal and ammonium salts are generally preferred, such as, for example, sodium, potassium and ammonium bifluoride. The acid etching stage according to the invention can advantageously be carried out by controlled acid attack, for a time which can vary as a function of the acid solution used and of the result desired (for example, for more than 2 minutes).

The basic etching according to the invention can be carried out conventionally by means of a controlled attack with a solution (for example, aqueous or an alcohol/water mixture) of one or more alkali metal hydroxides and/or carbonates (for example, LiOH, NaOH, KOH, K₂CO₃ or Na₂CO₃) at high temperature (for example, 300° C. or more). The basic attack can be carried out one or more times. Generally, the basic etching solutions have a pH of greater than 9 or, preferably, of greater than 10.

Of course, the invention also covers a method comprising at least two successive etching stages. This embodiment can consist of the repetition of one and the same etching stage (that is to say, with the same operating parameters/conditions) or, alternatively, it can consist of the sequence of etching stages with different operating parameters/conditions.

As illustrated in FIG. 1(b), the etching stage (2) thus makes it possible to obtain regions (5) which are etched, corresponding to the regions which were not covered beforehand by the mask (4).

Finally, the method of the invention comprises a finishing stage (3), during which the mask (4), that is to say the crosslinked composition, is removed. This stage can also encompass the removal of the etching solution and the rinsing of the glass sheet. The removal of the mask (4) can be carried out by projecting a liquid, such as an aqueous solution or an organic solution. An aqueous solution is preferably used and more preferably still water. Optionally, the aqueous solution can comprise a detergent and/or an organic solvent in order to help in removing the mask (4). The liquid can also be at a temperature greater than ambient temperature. Preferably, the projection of the liquid will be carried out by means of at least one pressurized jet directed onto the glass sheet or by means of a “curtain” applicator forming a liquid screen which pours over the glass sheet. The removal of the mask (4) can also be carried out by other industrial processes known for the cleaning of flat surfaces.

As illustrated in FIG. 1(b), stage (3) thus makes it possible to obtain the finished product, that is to say the selectively etched glass sheet. The selectively etched glass sheet obtained according to the method of the invention thus comprises:

(i) regions (5) which are etched, corresponding to the regions which were not covered beforehand by the mask (4), that is to say corresponding to the “negative” of the mask (4), and
(ii) smooth regions (6), corresponding to the regions which were covered by the mask (4).

According to the invention, the pattern(s) which it is desired to obtain on the glass sheet can be created by virtue of the etched regions (5) or alternatively by virtue of the smooth regions (6). The etched regions (5) or the smooth regions (6) can represent any pattern. It can be a logo, characters, texts, a drawing, and the like. The glass sheet obtained according to the method of the invention can comprise just one pattern or, alternatively, several identical or different patterns distributed over the glass sheet.

The patterns which the method according to the invention can create on the surface of the glass sheet have a size which can go down to approximately 500 microns and even down to 100 microns. Size is understood here to mean the greatest dimension of the pattern.

An etched glass is normally characterized by its roughness and in particular by the Rz and Rsm parameters (expressed in μm) and the ratio Rz/Rsm between these two parameters. According to one embodiment, the etched regions (5) of the glass sheet obtained according to the method of the invention exhibit a surface roughness defined by:

an Rz value of greater than 9 μm and less than 22 μm, and

an Rz/Rsm ratio of greater than 0.12 and less than 0.30.

Depending on the roughness obtained, the selectively etched glass sheet can have different applications. For example, it can be used for decorative applications or, if the roughness obtained is high, for applications as nonslip flooring, floor or staircase step.

The method according to the invention, comprising at least one cycle of three successive stages (1) to (3), can be carried out just once. In a specific embodiment of the invention, the cycle of the three stages (1) to (3) can be repeated a certain number of times until the desired aspect is achieved. In this embodiment of the invention, the cycles each comprising the 3 stages can use the same operating conditions at each repetition. The operating conditions can also be adapted from one cycle to the other. This embodiment can thus be used, for example, in order to obtain a heterogeneous etching or, in other words, in order to generate different etching intensities from one pattern to the other on the surface of one and the same glass sheet. In this case, the regions protected by the mask will be different from one repeat cycle to the other.

The method according to the invention can also be used to treat a glass sheet which is already completely etched. According to this embodiment, the regions under the mask are thus already etched and the unprotected regions can then be etched again, according to stage (2), in order to obtain an etching of greater intensity. Still according to this embodiment, alternatively, the unprotected regions can be etched, in stage (2), according to a treatment which makes it possible to regain a more or less smooth, non-scattering, glass surface. In this case, the scattering etched regions correspond to the pattern of the mask itself and no longer to the negative of the mask.

Of course, the invention is not limited to the selective etching of just one of the two faces of a glass sheet. The method, carried out on one face, can thus be repeated on the opposite face, with the same parameters and/or conditions or alternatively with different parameters and/or conditions from one face to the other.

The method according to the invention is particularly well-suited to the selective etching of large surface areas of glass, for example glass sheets for which the surface area is at least 5 m². It is understood that the method can also be easily used for the selective etching of smaller surface areas, for example surface areas of the order of 0.5 m².

According to the invention, the glass sheet obtained by the method according to the invention after the finishing stage (3) can be thermally or chemically tempered, or simply annealed or also hardened.

In order to observe certain safety standards, the glass sheet obtained by the method according to the invention after the finishing stage (3) can be laminated, that is to say that it is rolled with another glass sheet by means of a thermoplastic film.

The examples which follow illustrate the invention without the intention of limiting its coverage in any way.

### EXAMPLE 1

### Comparative

A clear glass sheet with a thickness of 4 mm and with a surface area of 2.25 m×3.21 m was washed with deionized water and then dried.

A mask made of paraffin-type wax (Paramelt, HG grade, melting point: 80-86° C.) was selectively deposited on certain parts of the surface of the glass by virtue of an inkjet head comprising 256 nozzles and brought to 110° C.

An acid etching solution, composed by volume of 50% NH₄HF₂, 25% water, 6% concentrated H₂SO₄, 6% of a 50% by weight aqueous HF solution, 10% K₂SO₄ and 3% (NH₄)₂SO₄, at 20-25° C., was subsequently deposited over the whole of the surface of the selectively protective glass and contact between the glass and the acid solution was maintained for 5 minutes. The solution was subsequently rinsed with water and the wax mask was subsequently removed with a jet of hot water. Finally, the surface was cleaned with an aqueous detergent.

A photograph obtained by optical microscopy of the surface of the treated glass sheet according to this example is presented in FIG. 2 and shows an edge of one of the etched patterns obtained. This photograph clearly illustrates the under-etching phenomenon, that is to say the etching under the edges of the wax mask. This under-etching produces, of course, a texturing of the glass which is less intense but this texturing is, however, clearly visible to the naked eye and results in a low sharpness of the outlines and an increase in the surface area of the textured pattern, in comparison with the negative of the mask applied. This is very critical in the case of very small desired patterns as this photograph shows an under-etching with a thickness of approximately 200 microns all along the edge of the pattern. Furthermore, this photograph also shows, over a more distant region, beyond the 200 microns from the edge of the mask, a multitude of small defects, that is to say a phenomenon of highly point-like etching under the mask, over the whole of its surface.

### EXAMPLE 2

### Comparative

A clear glass sheet with a thickness of 4 mm and with a surface area of 50 cm×50 cm was washed with deionized water and then dried.

A crosslinkable organic composition was selectivity deposited over certain parts of the surface of the sheet, according to the screen printing method, using a screen. The liquid composition used is a UV ink from Coates Screen Inks Gmbh.

After the deposition of the liquid composition on the glass sheet, the screen is removed and the liquid composition is crosslinked under UV.

An acid etching solution, composed by volume of 50% NH₄HF₂, 25% water, 6% concentrated H₂SO₄, 6% of a 50% by weight aqueous HF solution, 10% K₂SO₄ and 3% (NH₄)₂SO₄, at 20-25° C., was subsequently deposited over the whole of the surface of the selectively protective glass and contact between the glass and the acid solution was maintained for 5 minutes. The solution was subsequently removed by rinsing with water and then the mask was finally removed with a pressurized jet of an aqueous detergent solution.

A photograph obtained by optical microscopy of the surface of the treated glass sheet according to this example is presented in FIG. 3 and shows an edge of one of the etched patterns obtained. This photograph also shows a phenomenon of under-etching which results in a low sharpness of the outlines and an increase in the surface area of the textured pattern, in comparison with the negative of the mask applied. This etching under the edges of the mask is not as great as in the case of example 1 but remains a major disadvantage, for small patterns in particular, insofar as it has a thickness of approximately 70-80 microns all along the edge of the pattern.

### EXAMPLE 3

### In Accordance with the Invention

A clear glass sheet with a thickness of 4 mm and with a surface area of 2.25 m×3.21 m was washed with deionized water and then dried.

A crosslinkable organic composition was selectively deposited over certain parts of the surface of the sheet, different patterns of variable sizes (lines, grids, and the like) being represented. The organic composition used comprises N-vinylcaprolactam, an acrylate monomer, a photoinitiator and glycol ether acrylate.

The organic composition in the liquid form was deposited by inkjet by virtue of an assemblage of 48 inkjet heads (piezoelectric system of drops on-request) each comprising 128 nozzles. The crosslinking under UV was carried out simultaneously with the deposition.

An acid etching solution, composed by volume of 50% NH₄HF₂, 25% water, 6% concentrated H₂SO₄, 6% of a 50% by weight aqueous HF solution, 10% K₂SO₄ and 3% (NH₄)₂SO₄, at 20-25° C., was subsequently deposited over the whole of the surface of the selectively protective glass and contact between the glass and the acid solution was maintained for 5 minutes. The acid solution was subsequently removed and the mask was finally removed with a pressurized jet of water at ambient temperature.

A photograph obtained by optical microscopy of the surface of the treated glass sheet according to this example is presented in FIG. 4(a) and shows a line of crosslinked composition of approximately 1 mm, thus showing the edges of the mask according to the invention. A photograph obtained by optical microscopy of the same region as that observed in FIG. 4(a) but after etching and removing the mask is presented in FIG. 4(b), thus showing the edges of the etched region obtained. The photograph (b) shows a phenomenon of under-etching which is virtually nonexistent and in any case not visible to the naked eye (under-etching thickness ˜10 microns). Furthermore, the comparison of the photographs (a) and (b) makes it possible to see the virtually perfect identicality between the negative of the mask and the etched pattern obtained. Furthermore, the photograph (b) also shows an etched region with a very sharp and virtually straight outline, in comparison with the edges obtained in examples 1 and 2 (see FIGS. 2 and 3), which are very ill-defined.

A photograph of a region of the glass sheet, after etching and removal of the mask, is presented in FIG. 5, in which the pattern is created by virtue of the smooth regions which represent a grid (the mask deposited prior to the etching representing the same grid). The width of the lines of the grid is 200 microns.

1. A method for manufacturing a selectively etched glass sheet, comprising:
a) selectively depositing from at least one inkjet head to one face of a glass sheet a crosslinkable liquid organic composition, and crosslinking said composition by exposing it to ultraviolet radiation
b) chemically etching regions of the face of the glass sheet that are not covered by the crosslinked composition; and
c) removing the crosslinked composition from the face of the glass sheet.

2. The method as claimed in claim 1, wherein the liquid organic composition comprises at least one photoinitiator and a mixture of monomers and/or oligomers.

3. The method as claimed in claim 2, wherein the liquid organic composition comprises at least one photoinitiator, at least one oligomer and at least one comonomer capable of polymerizing with the oligomer.

4. The method as claimed in claim 2, wherein the liquid organic composition comprises at least one photoinitiator, at least one monomer and at least one comonomer capable of polymerizing with the monomer.

5. The method as claimed in claim 1, wherein, for a specific place to be protected of said face, the inkjet head provides liquid organic composition at least twice.

6. The method as claimed in claim 5, wherein, for a specific place to be protected of said face, the inkjet head provides liquid organic composition twice.

7. The method as claimed in claim 1, wherein the rate of the masking stage (1), expressed as surface area of the glass sheet, varies between 50 and 150 m² per hour.

8. The method as claimed in claim 1 wherein the chemical etching stage (2) is a basic etching.

9. The method as claimed in claim 1, wherein the chemical etching stage (2) is an acid etching.

10. The method as claimed in claim 1, wherein the crosslinking by exposure to ultraviolet radiation is virtually simultaneous or simultaneous with the deposition of the liquid composition.

11. The method as claimed in claim 1, wherein the masking stage (1) comprises several deposition/crosslinking cycles.

12. The method as claimed in claim 10, wherein the simultaneous deposition and crosslinking are combined with several deposition/crosslinking cycles.

13. The method as claimed in claim 1, wherein the glass sheet is a float glass sheet of soda-lime-silica type.

14. An etched glass plate made by the method of claim 1.
